(19) United States
(12) Patent Application Publication
(10) Pub. No.: US 2002/0089843 A1
(43) Pub. Date: Jul. 11, 2002

(54) Hand-held luminescent device

(76) Inventor: Tsz Ming Lou, Kowloon (HK)

Correspondence Address: BURNS DOANE SWECKER & MATHIS L L P, POST OFFICE BOX 1404, ALEXANDRIA, VA, 22313-1404, US

(21) Appl. No.: 09/755,123

(22) Filed: Jan. 8, 2001

(51) Int. Cl. F21L 4/00

(52) U.S. Cl. 362/96; 362/186; 362/208; 362/253

(57) ABSTRACT

A hand-held luminescent device including an air-inlet, an air-outlet and a hollow chamber joining said air-inlet and said air-outlet wherein said air-inlet is positioned at one longitudinal end of said hollow chamber, said air-inlet includes a simple aperture which does not block the reverse flow of air, a battery compartment is formed within said hollow chamber between said air-inlet and said air-outlet and a collar for compressively receiving the neck portion of an inflatable balloon is provided on said device at a position intermediate between said air-inlet and said air-outlet.

### FIELD OF THE INVENTION

The present invention relates to a hand-held luminescent device and, more particularly, to a hand-held luminescent device which is adapted to receive an inflatable balloon and having means on said device to inflate said inflatable balloon.

### BACKGROUND OF THE INVENTION

Hand-held luminescent devices having a luminous chamber which emits diffused light (more commonly known as “light rods”) are widely used in many occasions, for example, indoor and outdoor concerts, games, parades, social, religious and political gather or assemblies. The use of light rods by a large crowd in an assembly can create a spectacular visual effect as well as sending out powerful messages of, for example order, peace, solidarity and harmony. In addition to simply emitting diffused light, the luminous portion of a light rod can also be made into a variety of shapes or configurations, for example, cartoon figures, animals or geometrical shapes to attract children or to deliver a particular theme.

To enhance the visual effects deliverable by such light rods, an inflatable balloon may be inserted onto a light rod to enclose the luminous part of the light rod so that a considerably enlarged luminous chamber is created. Such an enlarged enclosure also provides a considerably large backdrop for projecting a variety of patterns, texts, or graphics originating from the actual luminous part of the light rod, thereby providing a useful screen on which a variety of messages, information, slogans or the like can be projected and displayed to suit different occasions or for different purposes.

Furthermore, light rods are usually substantially cylindrical with a rounded contour to avoid causing injuries to other people as they are frequently used in crowded environment. However, most light rods usually include a rigid luminous part inside which an electric light source is placed and the rigid part may cause personal injuries since people may swing light rods vigorously when they become excited and young children are known not to be good controllers of such devices. The use of a balloon enclosure provides a soft and flexible shield which may significantly reduce such risks.

When used with a light rod, a balloon has to be well inflated in order to make a good and effective projecting screen for a desirable pattern, texts or graphics to be satisfactorily displayed and to provide an effective safety buffering or merely to provide fun for young children. For this reason, it is desirable that a light rod is also provided with a mechanism for inflating the balloon so that a balloon can be inflated as and when needed. A conventional light rod with air inflation mechanism usually includes a radially protruding valve which extends normally from the longitudinally axis of the usually cylindrically shaped light rod. Such a radially extending valve is not only unsightly on an otherwise streamlined and symmetrical design but also creates hazardous of possible personal injury as the protruding parts may have sharp components which may cause scratches and cuts.

U.S. Pat. No. 5,499,941 issued to Penjuke describes a balloon fitted light rod having an longitudinally extending air-inlet at the longitudinal end of the light rod, however, compressed air inside an inflated balloon inserted on such a light rod will be drained rapidly as air will escape freely from the light rod before the air-inlet is sealed. The loose and flexible electric wires extending between the light rod and the power source in that patent may pose serious danger to the public in crowded environments.

Furthermore, conventional inflation mechanism usually comprises a valve having a moveable flap member which allows a uni-directional flow of compressed air. However, an air inflation valve having a moveable flap are known to be un-reliable and non-durable. Hence, it would be desirable if a light rod can be provided with a balloon inflating mechanism which alleviates the known shortcomings of conventional devices.

### OBJECTION OF THE INVENTION

It is therefore an object of the present invention to provide a hand-held luminescent device which is adapted to receive an inflatable balloon and provided with a mechanism for inflating the attached balloon while alleviating the afore-mentioned shortcomings. It is also an object of the present invention to provide the public at least with a useful choice of a hand-held luminescent device to be fitted with an inflatable balloon for a variety of occasions and purposes.

### SUMMARY OF THE INVENTION

According to a first aspect of the present invention, there is provided a hand-held luminescent device including an air-inlet, an air-outlet and a hollow chamber joining said air-inlet and said air-outlet wherein said air-inlet is positioned at one longitudinal end of said hollow chamber, said air-inlet includes a simple aperture which does not block the reverse flow of air, a battery compartment is formed within said hollow chamber between said air-inlet and said air-outlet and a collar for compressively receiving the neck portion of an inflatable balloon is provided on said device at a position intermediate between said air-inlet and said air-outlet.

Preferably, a printed circuit board having a battery contact and at least an aperture is inserted between said air-outlet and the end of said battery compartment which is near said air-outlet.

Preferably, the luminescent device further including an air baffle intermediate between said air-inlet and said air-outlet. Preferably, the air baffle is a printed circuit board which provides at least an electrical contact for the light source of said luminescent device. Preferably, the air baffle is a printed circuit board on which there is formed a battery contact.

Preferably, at least part of the device extending from the collar to the direction of the air-outlet is a luminescent part of the device. Preferably, the neck portion of said balloon is compressively held on the collar member of said device.

### BRIEF DESCRIPTION OF THE DRAWINGS

Preferred embodiments of the present invention will now be explained in more detail by way of example and with reference to the accompanying drawings, in which:—

FIG. 1 is a schematic diagram showing the longitudinal cross section of a hand-held luminescent device of a first embodiment of the present invention,

FIG. 2 is a luminescent device of FIG. 1 in combination with a partly inflated balloon which together forms a second embodiment of the present invention,

FIG. 3 is a schematic diagram showing the inflation process of the inflatable balloon of FIG. 2 through the luminescent device, and

FIG. 4 is a schematic diagram indicating air flow during the inflating process of FIG. 3.

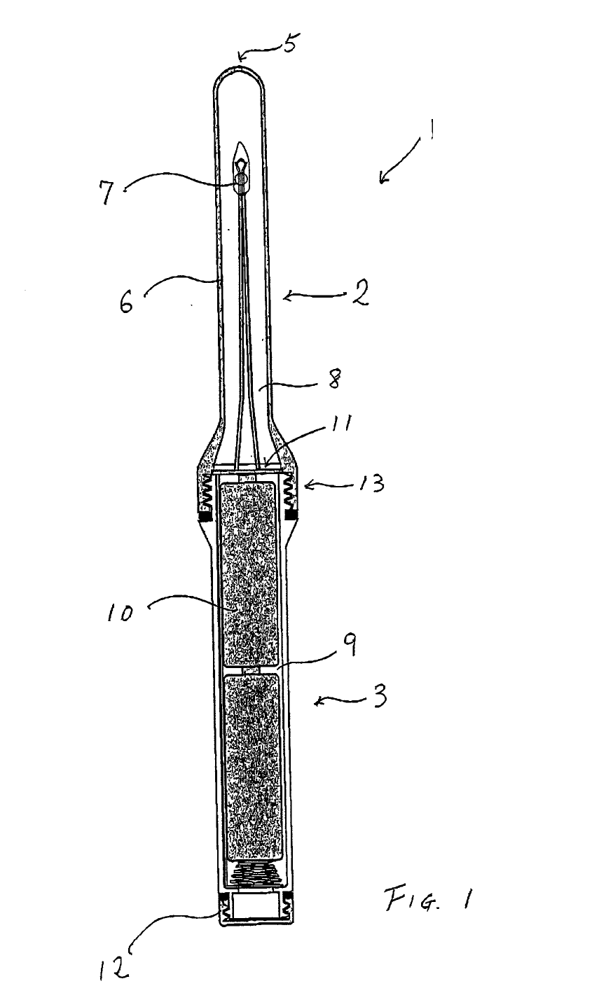

### DETAILED DESCRIPTION OF THE PREFERRED EMBODIMENTS

Referring to the Figures, there are shown preferred embodiments of a hand-held luminescent device (1) of the present invention which includes a luminous chamber (2) and a handle (3) and on which there are disposed an air-inlet (4) and at least all air-outlet (5). The luminous portion (2) includes a transparent or translucent rigid enclosing wall (6) inside which a light emitting source (7), for example, an electric light bulb or a light emitting diode (LED) is placed. The transparent or translucent enclosing wall can for example be made of a clear transparent plastic or a translucent plastic which diffuses the light generated by a concentrated light source. The inside of the hand-held device defies a hollow chamber (8) which extends between an air-inlet (4) and an air-outlet (5). The portion of the hollow chamber joining the air-inlet and air-outlet forms a conduit which defines a path for compressed air to flow from the air-inlet to the air-outlet only. A battery compartment (9) is formed intermediate between the air-inlet and the air-outlet to accommodate a battery (10) or batteries to power the light source. At the end of the battery compartment near the air-outlet (5), a battery contact is provided for connection and supplying power to the light emitting source.

An air baffle (11) having a plurality of defined apertures which controls the flow of air between the air-inlet and the air-outlet may be placed intermediate between the inlet and outlet to control or regulate the reverse flow of compressed air from the air-outlet to the air-inlet. The battery contact which is near the air-outlet is formed on a piece of printed circuit board (“PCB”) which is retained within the hollow chamber by, for example, a circumferential groove formed inside the chamber. As the PCB should preferably extend transversally across the entire cross-sectional space of the hollow chamber in order to be securely held, the PCB will become a total air-block unless means are provided to divert air flow across the PCB. In the present preferred embodiment, at least an aperture is formed on the PCB to allow air passage through the PCB so that the PCB become a synergetic member which provides the necessary electrical contacts for the light source as well as becoming an air baffle which limits the reverse air-flow. Of course, instead of forming an aperture on the PCB, the PCB may be made into a shape which does not wholly block the air passage way so that the same effect can be achieved.

The other end of the battery compartment facing the air-inlet is provided with a removable cap (12) which is provided for sealing the air-inlet once the balloon has been satisfactory inflated. The removable cap is also provided with an electric contact which, together with a electric conductor extending along the battery compartment, will complete the electric circuit between the light emitting source and the battery (or batteries) placed inside the battery compartment.

To tightly and compressively retain the neck portion of an inflatable balloon (20), a collar (13) is formed on the hand-device at a position intermediate between the air-outlet and the air-inlet. To provide a firm and air-tight grip on the neck-portion (21) of the balloon, the collar portion of the hand-held device may be considerably enlarged or expanded. Of course additional fasteners may be provided to latch the balloon to stay in position. In order to allow adequate illumination of the inflated balloons it is preferable that at least part of the portion of the hand-held device which is beyond the collar member (13) and the air-inlet is luminescent when the light emitting source is activated. To allow easy service of the light emitting source, the hand-held device may be separated at the junction near the end of the battery compartment or the collar portion so that the light source may be replaced or the electrical connection may be repaired. To improve the air-tightness, elastomeric O-rings may be used to seal the removable or separable parts.

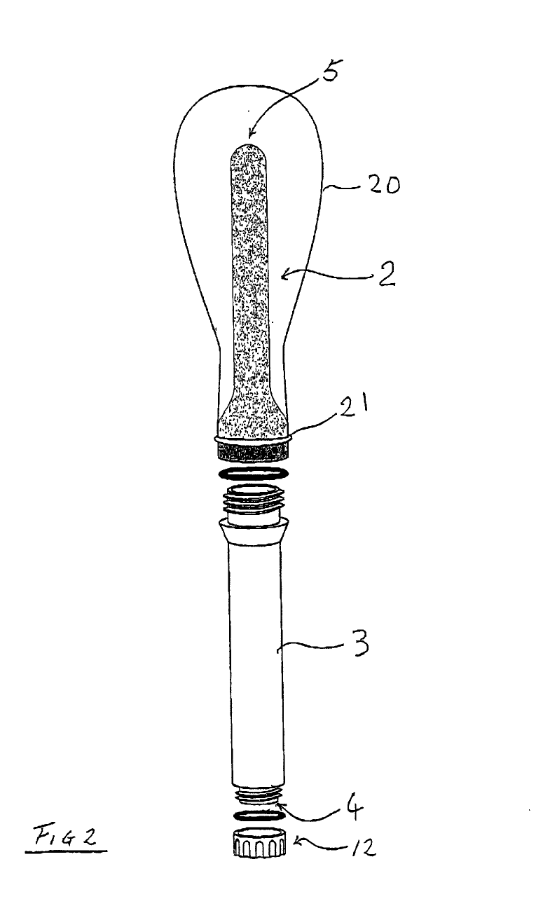

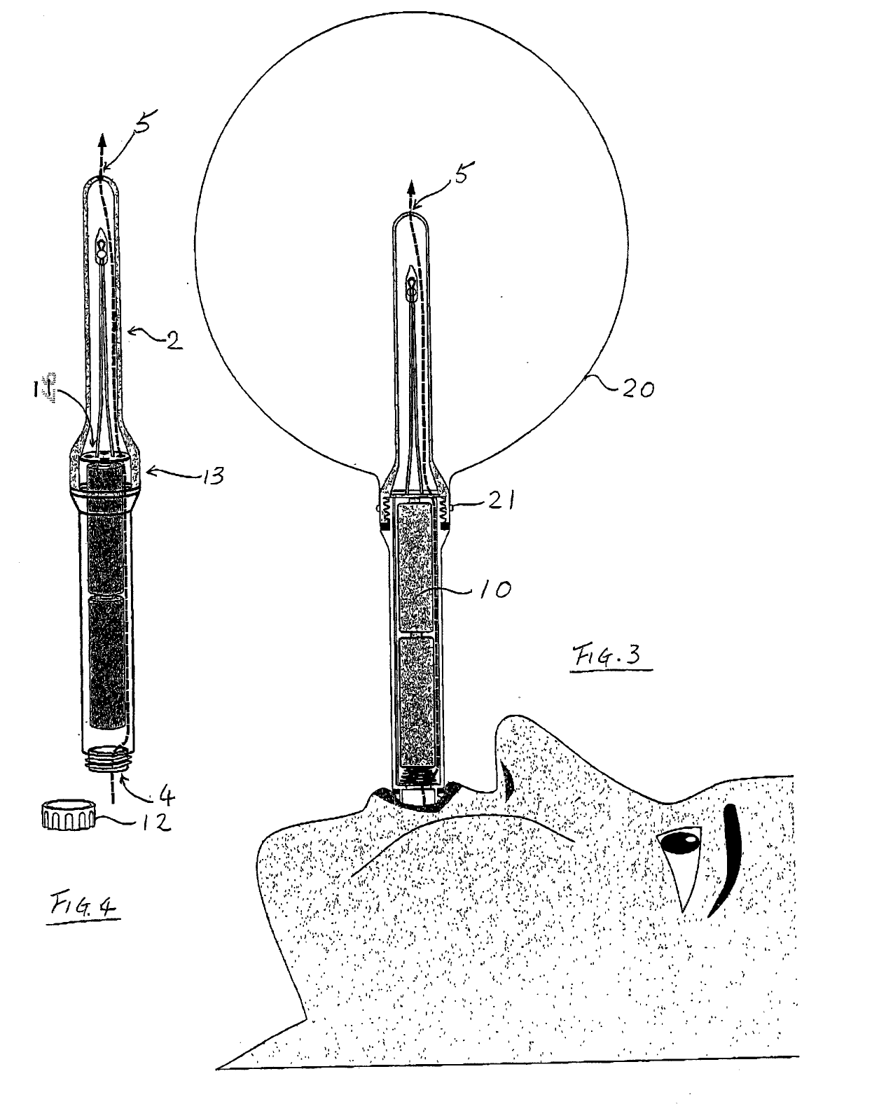

A second preferred embodiment of the present invention is shown in FIGS. 2 and 3 in which the luminescent hand-held device is combined with an inflatable balloon (20) having its neck portion being received on the expanded collar portion (13) of the hand-held device. In the normal use of the combined hand-held device with an inflatable balloon, the neck portion of an inflatable balloon is first attached to the, collar of the hand-held device. Compressed air is then blown into the hollow chamber through the air-inlet by removing the sealing cap. The compressed air travels from the air-inlet through the battery compartment and enters the inflatable balloon through the air-outlet. Once the balloon has been inflated to a desirable size, the air-inlet can be sealed with the sealing cap and O-ring.

To control or slow down the rate of reverse air flow from the air-outlet back to the air-inlet, an air baffle with defined apertures is placed intermediate between the air-inlet and the air-outlet. As a battery or batteries will also be placed in the battery compartment which is positioned intermediate between the air-outlet and air-inlet, the reverse-flow of the compressed air will her be slowed down by the battery or batteries and the inflated shape of the balloon can be reasonably maintained. Hence, the battery or batteries also serve as an slidable air baffle.

While the air-outlet in the present embodiments has been positioned at the longitudinal end of the hand-held device, it will be appreciated that the air-outlet or a plurality of air-outlets can be positioned anywhere along the hand-held device as long as they are positioned beyond the collar portion and away from the air-inlet. Furthermore, while the present invention has been explained with reference to a substantially plain and cylindrical light rod, it will be appreciated that the luminous portion of the device can be made into various shapes and configurations to make the device more aesthetically appealing. Furthermore, while the present embodiments have been explained with reference to a sealing cap having screw-threads with corresponding screw-threads extending from the device stem, it will be appreciated that other forms of sealing caps, for example, snap-fit caps, can be used. Furthermore, it shall be appreciated that the preferred embodiments are only simple examples used to illustrate the implementation of the present invention, it should be appreciated that the scope of the invention shall not be limited strictly to the examples used which are solely used for illustrative purposes only.

1. A hand-held luminescent device including an air-inlet, an air-outlet and a hollow chamber joining said air-inlet and said air-outlet wherein said air-inlet is positioned at one longitudinal end of said hollow chamber, said air-inlet includes a simple aperture which does not block the reverse flow of air, a battery compartment is formed within said hollow chamber between said air-inlet and said air-outlet and a collar for compressively receiving the neck portion of an inflatable balloon is provided on said device at a position intermediate between said air-inlet and said air-outlet.

2. A hand-held luminescent device according to claim 1, wherein a printed circuit board having a battery contact and at least an aperture is inserted between said air-outlet and the end of said battery compartment which is near said air-outlet.

3. A hand-held luminescent device according to claim 1, further including an air baffle intermediate between said air-inlet and said air-outlet.

4. A hand-held luminescent device according to claim 3, wherein said air baffle is a printed circuit board which provides at least an electrical contact for the light source of said device.

5. A hand-held luminescent device according to claim 3, wherein said air baffle is a printed circuit board on which there is formed a battery contact.

6. A hand-held luminescent device according to claim 1, wherein at least part of the device extending from the collar to the direction of the air-outlet is a luminescent part of the device.

7. A hand-held luminescent device according to claim 1, where said air-inlet is sealable by a sealing cap.

8. A hand-held luminescent device according to claim 1, further including an inflatable balloon wherein the neck portion of said balloon is compressively held on the collar member of said device.
